(19) United States
(12) Patent Application Publication
(10) Pub. No.: US 2022/0090561 A1
(43) Pub. Date: Mar. 24, 2022

(54) Motor and Fuel-Powered Hybrid System for a Rocket Thruster

(71) Applicant: TAIWAN INNOVATIVE SPACE, INC., MIAOLI COUNTY (TW)

(72) Inventor: Yen-Sen CHEN, MIAOLI COUNTY (TW)

(73) Assignee: Taiwan Innovative Space, Inc.

(21) Appl. No.: 16/948,516

(22) Filed: Sep. 22, 2020

(51) Int. Cl. F02K 9/52; F02K 9/60

(52) U.S. Cl. CPC F02K 9/52; F02K 9/605

(57) ABSTRACT

A motor and fuel-powered hybrid system of a rocket thruster is disclosed, which mainly provides power through a motor and a fluid fuel injector. In particular, at the beginning stage of the rocket lift-off, the motor drives the compressor to provide power to send the rocket into air. When the speed and height of the rocket gradually increase, the fuel is ignited to give power to keep propelling the rocket, thereby reducing the fluid fuel that needs to be carried on the rocket, increasing the rocket's loading space and enhancing the carrying capacity.

### BACKGROUND

### Field of the Invention

The present invention relates to a rocket, and more particularly to a motor and fuel-powered hybrid system for a rocket thruster.

### Related Prior Art

At present, the most common rocket thrusters are mainly solid rocket thrusters, liquid rocket thrusters or hybrid rocket thrusters, and because hybrid rocket thrusters have the characteristics of being able to control thrust, relatively low cost, and have higher safety, the number of hybrid rocket thrusters is the largest compared to others.

It is worth mentioning that although hybrid rockets are easier to control their thrust than pure liquid or solid rockets, they still have many inconveniences in use. For example: the use of the mixing of fluid fuel and solid fuel as propulsion fuel from the beginning of lift-off results in the need to reserve a lot of fluid fuel for rocket lift-off on the rocket. Relatively, it is necessary to calculate the possible offset of the rocket after the fluid fuel is reduced, and then adjust the thrust of the rocket thruster according to the calculation results.

The most important thing to note is that since the fluid fuel required for the rocket to lift off from the ground to space must be prepared on the rocket body, in order to prepare enough fluid fuel for lift-off, a lot of space on the rocket body is used to store fluid fuel, resulting in a small amount of equipment that can be installed in the rocket, and thus the weight ratio of the objects that the rocket can carry is extremely low.

In view of this, it is indeed necessary to provide a technical means to solve the problem of extremely low weight ratio of objects that the rocket can carry.

### SUMMARY

One objective of the present invention is to solve the problem of extremely low weight ratio of objects that the rocket can carry.

To achieve the above objective, a motor and fuel-powered hybrid system for a rocket thruster provided by the invention comprises:

a casing including a first tank, a second tank, and a third tank that are connected in sequence, the first tank including an air inlet and a first space communicating with each other, the second tank including a second space communicating with the first space, and the third tank including a third space communicating with the second space;

a motor disposed in the first tank, and including a central processing system, and a compressor that is power connected to the central processing system;

a fluid fuel injector disposed on the casing, controllingly connected to the central processing system, and including an injection head extending into the second tank, and the injection head being arranged toward the third tank to spray fluid fuel; and

an igniter disposed in the third tank and controllingly connected to the central processing system, and being used for igniting fluid fuel;

by such arrangements, there are a first stage, a second stage and a third stage, in the first stage, the central processing system drives the compressor to operate, and the compressor provides kinetic energy, the rocket enters the second stage when raised to a certain height, in the second stage, the central processing system controls the compressor to gradually reduce load, in the third stage, the central processing system drives the fluid fuel injector to inject fluid fuel toward the third tank provide kinetic energy, and in the first, second and third stages, the amounts of fluid fuel that the fluid fuel injector controls the central processing system to inject are the same.

In another solution, a motor and fuel-powered hybrid system for a rocket thruster provided by the invention comprises:

a casing including a first tank, a second tank, and a third tank that are connected in sequence, the first tank including an air inlet and a first space communicating with each other, the second tank including a second space communicating with the first space, and the third tank including a third space communicating with the second space;

a motor disposed in the first tank, and including a central processing system, and a compressor that is power connected to the central processing system;

a fluid fuel injector disposed on the casing, controllingly connected to the central processing system, and including an injection head extending into the second tank, and the injection head being arranged toward the third tank to spray fluid fuel; and

an igniter disposed in the third tank and controllingly connected to the central processing system, and being used for igniting fluid fuel.

In a proffered embodiment, a nozzle is connected to the third tank, and the nozzle includes a passage penetrating and communicating with the third space.

In a proffered embodiment, the central processing system includes a processing unit, a power supply, and an electric motor, the processing unit is controllingly connected to the power supply, the power supply is electrically connected to the electric motor, and the electric motor is power connected to the compressor.

In a proffered embodiment, the power supply takes the form of lithium ion batteries or hydrogen fuel cells.

In a proffered embodiment, the compressor is an axial compressor.

In a proffered embodiment, an interior of the fluid fuel injector is used for storage of hydrocarbon fuel.

In a proffered embodiment, the igniter is an autotransformer.

In a proffered embodiment, a mixing enhancer is disposed in the second tank, and located between the nozzle and the third space of the third tank.

Since the first stage of rocket lift-off is mainly achieved by the compressor, and the compressor is driven by the power supply in the central processing system, the weight of the power supply is much smaller than that of the fluid fuel, and in the second stage the load of the compressor is gradually reduced, so that the rocket can also increase the speed to super high speed. Because the rocket only starts to use fluid fuel in the second stage, the volume of fluid fuel that needs to be stored on the rocket is greatly reduced, so that the rocket can be loaded with more equipment, and the rocket's load ratio is greatly increased.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a schematic diagram of the structure of the present invention in a preferred embodiment;

FIG. 2 is a graph of the injection conditions of the motor and the fluid fuel injector of the present invention in comparison with conventional hybrid rockets.

### DETAILED DESCRIPTION

The present invention will be clearer from the following description when viewed together with the accompanying drawings, which show, for purpose of illustrations only, the preferred embodiment in accordance with the present invention.

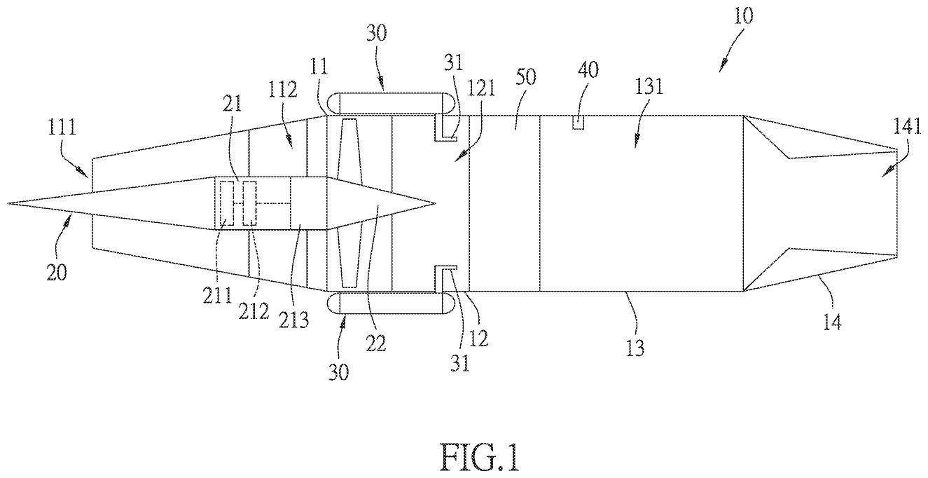

Referring to FIG. 1, the present invention is a motor and fuel-powered hybrid system for rocket thruster, which essentially comprises: a casing 10, the motor 20, a fluid fuel injector 30 and an igniter 40.

The casing 10 includes a first tank 11, a second tank 12, and a third tank 13 that are connected in sequence. The first tank 11 includes an air inlet 111 and a first space 112 communicating with each other, the second tank 12 includes a second space 121 communicating with the first space 112, and the third tank 13 includes a third space 131 communicating with the second space 121. In this embodiment, the invention further includes a nozzle 14 connected to the third tank 13, and the nozzle 14 includes a passage 141 penetrating and communicating with the third space 131.

The motor 20 is disposed in the first tank 11, and includes a central processing system 21, and a compressor 22 that is power connected to the central processing system 21. In this embodiment, the central processing system 21 includes a processing unit 211 (Central Processing Unit/CPU), a power supply 212, and an electric motor 213. The processing unit 211 is controllingly connected to the power supply 212 to control the amount of power supplied from the power supply 212 to the electric motor 213. The power supply 212 is electrically connected to the electric motor 213, and can take the form of lithium ion batteries or hydrogen fuel cells to provide the electric motor 213 energy. The electric motor 213 is power connected to the compressor 22 to drive the compressor 22 to operate, and the compressor 22 can be an axial compressor 22.

The fluid fuel injector 30 is disposed on the casing 10, controllingly connected to the central processing system 21, and includes an injection head 31 extending into the second tank 12, and the injection head 31 is arranged toward the third tank 13 to spray fluid fuel. In this embodiment, the interior of the fluid fuel injector 30 is used for storage of hydrocarbon fuel. Hydrocarbon fuel is a bio-fluid fuel that can replace petrochemical diesel and is a substitute for petroleum energy. Hydrocarbon fuel is a fluid fuel that can be produced through a lipid exchange reaction using various lipid compounds (rapeseed oil, cottonseed oil . . . etc. various vegetable oils) and methanol as raw materials, under the action of a catalyst.

The igniter 40 is disposed in the third tank 13 and controllingly connected to the central processing system 21, and is used for igniting fluid fuel. In this embodiment, the igniter 40 is an autotransformer, and the central processing system 21 controls the increase or decrease of its voltage, so that the igniter 40 can generate a spark at a specific time point and ignite the fluid fuel in the third tank 13.

Thereby, there are a first stage, a second stage and a third stage. In the first stage, the central processing system 21 drives the compressor 22 to operate, and the compressor 22 provides kinetic energy. After the rocket is raised to a certain height, it enters the second stage. In the second stage, the central processing system 21 controls the compressor 22 to gradually reduce the load, and in the third stage, the central processing system 21 drives the fluid fuel injector 30 to inject fluid fuel toward the third tank 13, and the fluid fuel injector 30 provides kinetic energy. It is worth mentioning that in the first, second and third stages, the amounts of fluid fuel that the fluid fuel injector 30 controls the central processing system 21 to inject are the same.

Among them, there is a mixing enhancer 50 disposed in the second tank 12, and the mixing enhancer 50 is located between the nozzle 14 and the third space 131 of the third tank 13. When the nozzle 14 injects fluid fuel toward the third tank 13, the fluid fuel will first pass through the mixing enhancer 50 and then enter the third space 131 of the third tank 13.

The above is the structural configuration and connection relationship of the present invention in a preferred embodiment. The use of the present invention and the effects it can produce are as follows:

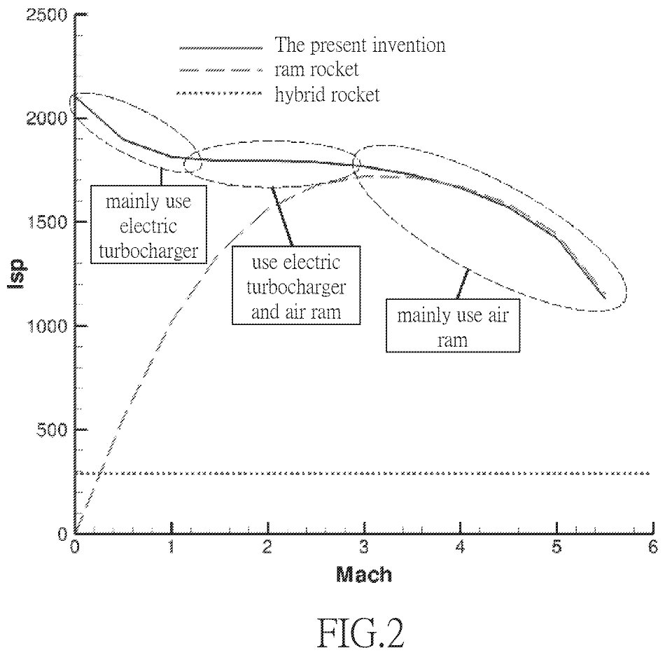

Referring to FIGS. 1 and 2, the motor and the fuel power mixing system of a rocket thruster of the present invention mainly has three stages in use. In the first stage, the central processing system 21 first controls the compressor 22 to start, and then controls the fluid fuel injector 30 to inject a small amount of hydrocarbon fuel, so that air enters the first space 112 from the air inlet 111 and passes through the compressor 22. When the air passes through the compressor 22, it becomes high pressure and sequentially passes through the second space 121, the third space 131 and the passage 141, thereby allowing the rocket to be propelled into the air mainly by the compressor 22.

After the rocket lifted off through the compressor 22, the central processing system 21 controls the compressor 22 to reduce the load, and controls the fluid fuel injector 30 to continuously inject a small amount of hydrocarbon fuel. In the second stage, the power generated by igniting the hydrocarbon fuel is combined with the power generated by the compressor 22 to keep propelling the rocket. Therefore, in the second stage, the combination of the power generated by the ignition of the hydrocarbon fuel and the power generated by the compressor 22 is used to propel the rocket.

In the third stage, as the power of the power supply 212 is gradually exhausted, the central processing system 21 controls the compressor 22 to reduce the load, the fluid fuel injector 30 injects hydrocarbon fuel toward the third tank 13, and the power generated by ignition and combustion of the hydrocarbon fuel is used to propel the rocket.

Since the first stage of rocket lift-off is mainly achieved by the compressor 22, and the compressor 22 is driven by the power supply 212 in the central processing system 21, the weight of the compressor 22 is much smaller than that of the fluid fuel, and in the second stage the load of the compressor 22 is gradually reduced, so that the rocket can also increase the speed to super high speed. In the third stage, the central processing system 21 controls the reduction of the load of the compressor 22, and mainly uses fluid fuel to provide kinetic energy, therefore, the volume of fluid fuel that needs to be stored on the rocket is greatly reduced, so that the rocket can be loaded with more equipment, and the rocket's load ratio is greatly increased.

While we have shown and described various embodiments in accordance with the present invention, it is clear to those skilled in the art that further embodiments may be made without departing from the scope of the present invention.

1. A motor and fuel-powered hybrid system for a rocket thruster, comprising:
a casing including a first tank, a second tank, and a third tank that are connected in sequence, the first tank including an air inlet and a first space communicating with each other, the second tank including a second space communicating with the first space, and the third tank including a third space communicating with the second space;
the motor disposed in the first tank, and including a central processing system, and a compressor that is power connected to the central processing system;
a fluid fuel injector disposed on the casing, controllingly connected to the central processing system, and including an injection head extending into the second tank, and the injection head being arranged toward the third tank to spray fluid fuel; and
an igniter disposed in the third tank and controllingly connected to the central processing system, and being used for igniting fluid fuel;
there are a first stage, a second stage and a third stage, in the first stage, the central processing system drives the compressor to operate, and the compressor provides kinetic energy, the rocket enters the second stage when raised to a certain height, in the second stage, the central processing system controls the compressor to gradually reduce load, in the third stage, the central processing system drives the fluid fuel injector to inject fluid fuel toward the third tank to provide kinetic energy, and in the first, second and third stages, the amounts of fluid fuel that the fluid fuel injector controls the central processing system to inject are the same.

2. The motor and fuel-powered hybrid system for the rocket thruster as claimed in claim 1 further comprising a nozzle connected to the third tank, and the nozzle includes a passage penetrating and communicating with the third space.

3. The motor and fuel-powered hybrid system for the rocket thruster as claimed in claim 1, wherein the central processing system includes a processing unit, a power supply, and an electric motor, the processing unit is controllingly connected to the power supply, the power supply is electrically connected to the electric motor of the central processing system, and the electric motor of the central processing system is power connected to the compressor.

4. The motor and fuel-powered hybrid system for the rocket thruster as claimed in claim 3, wherein the power supply takes the form of lithium ion batteries or hydrogen fuel cells.

5. The motor and fuel-powered hybrid system for the rocket thruster as claimed in claim 3, wherein the compressor is an axial compressor.

6. The motor and fuel-powered hybrid system for the rocket thruster as claimed in claim 1, wherein an interior of the fluid fuel injector is used for storage of hydrocarbon fuel.

7. The motor and the fuel power mixing system of the rocket thruster as claimed in claim 1, wherein the igniter is an autotransformer.

8. The motor and fuel-powered hybrid system for the rocket thruster as claimed in claim 2 further comprising a mixing enhancer disposed in the second tank, and located between the nozzle and the third space of the third tank.

9. A motor and fuel-powered hybrid system for a rocket thruster, comprising:
a casing including a first tank, a second tank, and a third tank that are connected in sequence, the first tank including an air inlet and a first space communicating with each other, the second tank including a second space communicating with the first space, and the third tank including a third space communicating with the second space;
the motor disposed in the first tank, and including a central processing system, and a compressor that is power connected to the central processing system;
a fluid fuel injector disposed on the casing, controllingly connected to the central processing system, and including an injection head extending into the second tank, and the injection head being arranged toward the third tank to spray fluid fuel; and
an igniter disposed in the third tank and controllingly connected to the central processing system, and being used for igniting fluid fuel.

10. The motor and fuel-powered hybrid system for the rocket thruster as claimed in claim 9 further comprising a nozzle connected to the third tank, and the nozzle includes a passage penetrating and communicating with the third space.

11. The motor and fuel-powered hybrid system for the rocket thruster as claimed in claim 9, wherein the central processing system includes a processing unit, a power supply, and an electric motor, the processing unit is controllingly connected to the power supply, the power supply is electrically connected to the electric motor of the central processing system, and the electric motor of the central processing system is power connected to the compressor.

12. The motor and fuel-powered hybrid system for the rocket thruster as claimed in claim 11, wherein the power supply takes the form of lithium ion batteries or hydrogen fuel cells.

13. The motor and fuel-powered hybrid system for the rocket thruster as claimed in claim 11, wherein the compressor is an axial compressor.

14. The motor and fuel-powered hybrid system for the rocket thruster as claimed in claim 9, wherein an interior of the fluid fuel injector is used for storage of hydrocarbon fuel.

15. The motor and fuel-powered hybrid system for the rocket thruster as claimed in claim 9, wherein the igniter is an autotransformer.

16. The motor and fuel-powered hybrid system for the rocket thruster as claimed in claim 10 further comprising a mixing enhancer disposed in the second tank, and located between the nozzle and the third space of the third tank.
